(19) United States
(12) Patent Application Publication
(10) Pub. No.: US 2025/0155669 A1
(43) Pub. Date: May 15, 2025

(54) DRIVING MECHANISM

(71) Applicant: TDK TAIWAN CORP., Taoyuan City (TW)

(72) Inventors: Kai-Po FAN, Taoyuan City (TW); Man-Ting LU, Taoyuan City (TW); Shou-Jen LIU, Taoyuan City (TW)

(21) Appl. No.: 18/945,041

(22) Filed: Nov. 12, 2024

Related U.S. Application Data
(60) Provisional application No. 63/597,919, filed on Nov. 10, 2023.

(51) Int. Cl. G02B 7/09; G02B 7/18; G02B 27/64

(52) U.S. Cl. CPC G02B 7/09; G02B 7/1805; G02B 27/646

(57) ABSTRACT

A driving mechanism for moving an optical element is provided. The driving mechanism includes a fixed part, a movable part, and a driving assembly. The movable part is movably connected to the fixed part for holding the optical element. The driving assembly is configured for moving the movable part relative to the fixed part.

### CROSS REFERENCE TO RELATED APPLICATIONS

This application claims the benefit of U.S. Provisional Application No. 63/597,919, filed Nov. 10, 2023, the entirety of which is incorporated by reference herein.

### BACKGROUND OF THE INVENTION

### Field of the Invention

The present invention relates to a driving mechanism, and, in particular, to a driving mechanism for moving an optical element.

### Description of the Related Art

As technology has advanced, a lot of electronic devices (for example, laptop computers and smartphones) have incorporated the functionality of taking photographs and recording video. These electronic devices have become more commonplace, and have been developed to be more convenient and thin. More and more options are provided for users to choose from.

In some electronic devices, several coils and magnets corresponding thereto are usually used for adjusting the focus of a lens. However, miniaturization of these electronic devices may increase the difficulty of mechanical design, and it may also lead to low reliability and low driving force for moving the lens. Therefore, addressing the aforementioned problems has become a challenge.

### BRIEF SUMMARY OF THE INVENTION

An embodiment of the present invention provides a driving mechanism for moving an optical element. The driving mechanism includes a fixed part, a movable part, and a driving assembly. The movable part is movably connected to the fixed part for holding the optical element. The driving assembly is configured for moving the movable part relative to the fixed part.

In some embodiments, the driving mechanism further includes a rod extending in a horizontal direction. The fixed part includes a base and a housing connected to each other, the rod is affixed to the base, and the movable part is slidably disposed on the rod.

### BRIEF DESCRIPTION OF THE DRAWINGS

The present invention can be more fully understood by reading the subsequent detailed description and examples with references made to the accompanying drawings, wherein:

FIG. 1 shows a perspective diagram of an optical system 100 in accordance with an embodiment of the invention.

FIG. 2 shows a cross-sectional view of the optical system 100 in FIG. 1.

FIG. 3 shows a perspective diagram of the driving mechanism 10 in FIG. 1.

FIG. 4 shows a perspective diagram of the driving mechanism 20 in FIG. 1.

FIG. 5 shows an exploded diagram of the driving mechanism 20 in FIG. 4.

FIG. 6 shows a cross-sectional view of the optical elements L1, L2 and the driving mechanism 20 after assembly, wherein the housing H is omitted from FIG. 6.

FIG. 7 shows an enlarged cross-sectional view of the first end portion 231 of the rod 23 extending into the first hole h1 of the first sidewall BW1.

FIG. 8 shows an enlarged cross-sectional view of the second end portion 232 of the rod 23 extending into the second hole h2 of the first sidewall BW2.

FIG. 9 shows a side view of the printed circuit element 21, the substrates P, the magnetic elements M, the coils C, the rods 32, and the holder LH after assembly.

FIG. 10 shows a perspective view of a curved surface BP1 and a cavity BP2 formed on the protrusion BP of the base B.

FIG. 11 shows an exploded view of the substrate P, the coil C, and a metal frame T in FIG. 5.

FIG. 12 shows another exploded view of the substrate P, the coil C, and the metal frame T in FIG. 5.

FIG. 13 shows a perspective diagram of the substrate P, the coil C, and the metal frame T after assembly.

FIG. 14 shows another perspective diagram of the substrate P, the coil C, and the metal frame T after assembly.

FIG. 15 shows a top view of the optical elements L1, L2, the rods 23, the printed circuit element 21, the substrates P, and the coils C after assembly.

FIG. 16 shows a perspective diagram of the driving mechanism 20 when the housing H is removed therefrom.

### DETAILED DESCRIPTION OF THE INVENTION

The making and using of the embodiments of the driving mechanism are discussed in detail below. It should be appreciated, however, that the embodiments provide many applicable inventive concepts that can be embodied in a wide variety of specific contexts. The specific embodiments discussed are merely illustrative of specific ways to make and use the embodiments, and do not limit the scope of the disclosure.

Unless defined otherwise, all technical and scientific terms used herein have the same meaning as commonly understood by one of ordinary skill in the art to which this invention belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

In the following detailed description of the preferred embodiments, reference is made to the accompanying drawings, and in which specific embodiments of which the invention may be practiced are shown by way of illustration. In this regard, directional terminology, such as “top,” “bottom,” “left,” “right,” “front,” “back,” etc., is used with reference to the orientation of the figures being described. The components of the present invention can be positioned in a number of different orientations. As such, the directional terminology is used for the purposes of illustration and is in no way limiting.

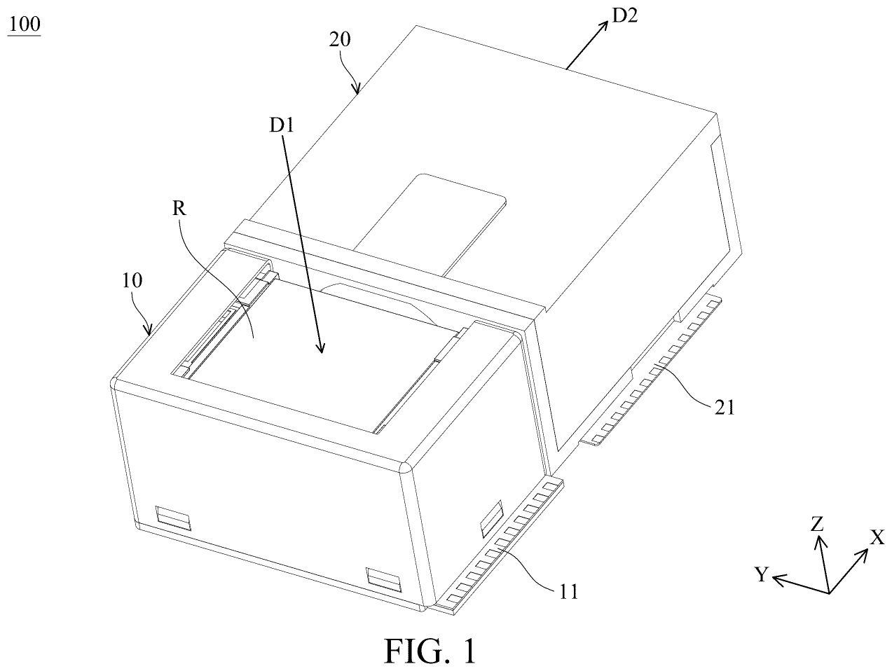

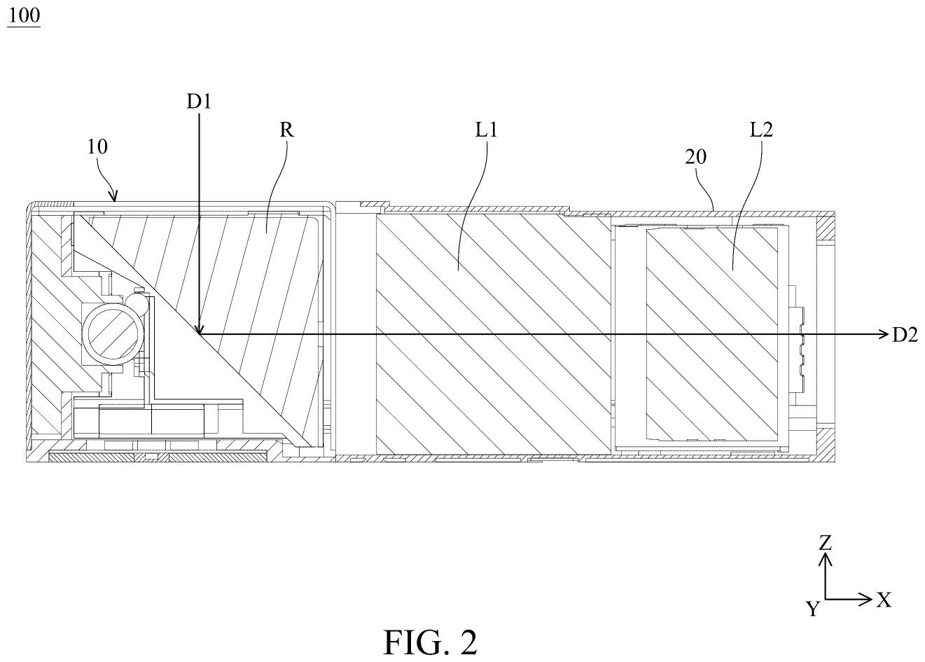

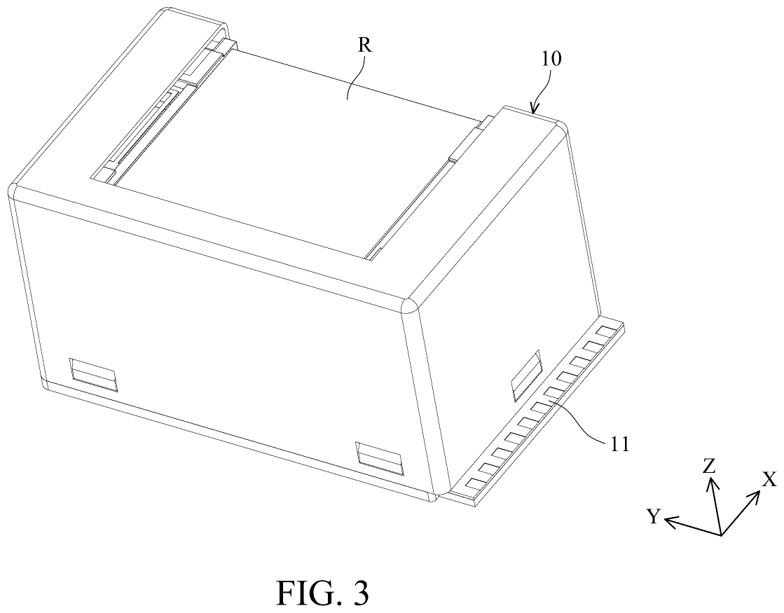

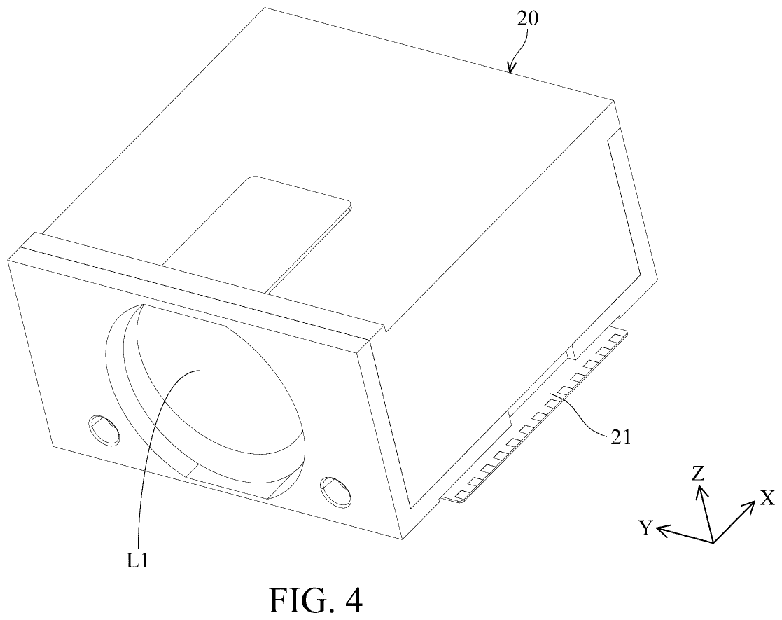

FIG. 1 shows a perspective diagram of an optical system 100 in accordance with an embodiment of the invention. FIG. 2 shows a cross-sectional view of the optical system 100 in FIG. 1. FIG. 3 shows a perspective diagram of the driving mechanism 10 in FIG. 1. FIG. 4 shows a perspective diagram of the driving mechanism 20 in FIG. 1.

Referring to FIGS. 1-4, the optical system 100 in this embodiment may be disposed in a cell phone or other portable electronic device. The optical system 100 primarily comprises two driving mechanisms 10, 20 and three optical elements R, L1, L2. The optical element R may be a prism that is disposed in the driving mechanism 10, and the optical elements L1, L2 may be optical lenses that are disposed in the driving mechanism 20.

In this embodiment, the driving mechanisms 10 and 20 may comprise Voice Coil Motors (VCMs) for rotating the optical element R and/or moving the optical element L2 along the X axis, thereby achieving the function of Auto Focusing (AF) or Optical Image Stabilization (OIS).

With the configuration as described above, external light can enter the optical element R in a vertical direction (−Z direction). External light is then reflected by the optical element R and propagates through the optical elements L1 and L2 in a horizontal direction (X direction). Subsequently, light propagates out of the optical system 100 and reaches an image sensor (not shown) to form a digital image.

As shown in FIGS. 1-4, two printed circuit elements 11, 21 (e.g. PCB or FPC) are disposed on the bottom side of the driving mechanisms 10 and 20. External circuit can apply current signals through the printed circuit elements 11, 21 to the coils in the driving mechanisms 10, 20. Hence, electromagnetic forces can be generated to rotate/move the optical elements R, L1, L2, thereby achieving the function of Auto Focusing (AF) or Optical Image Stabilization (OIS).

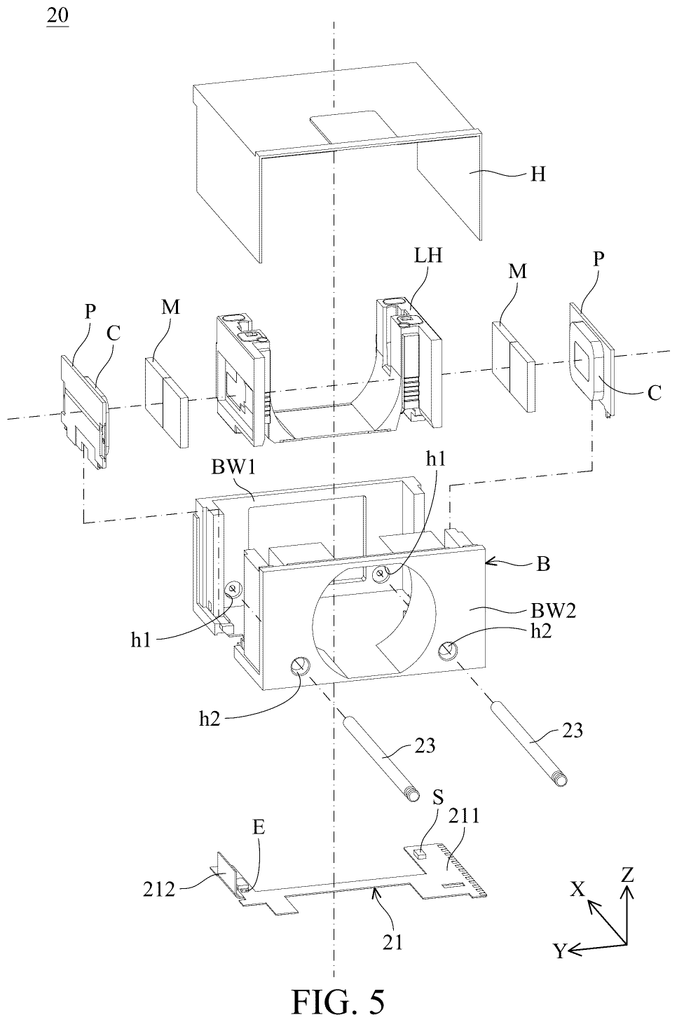

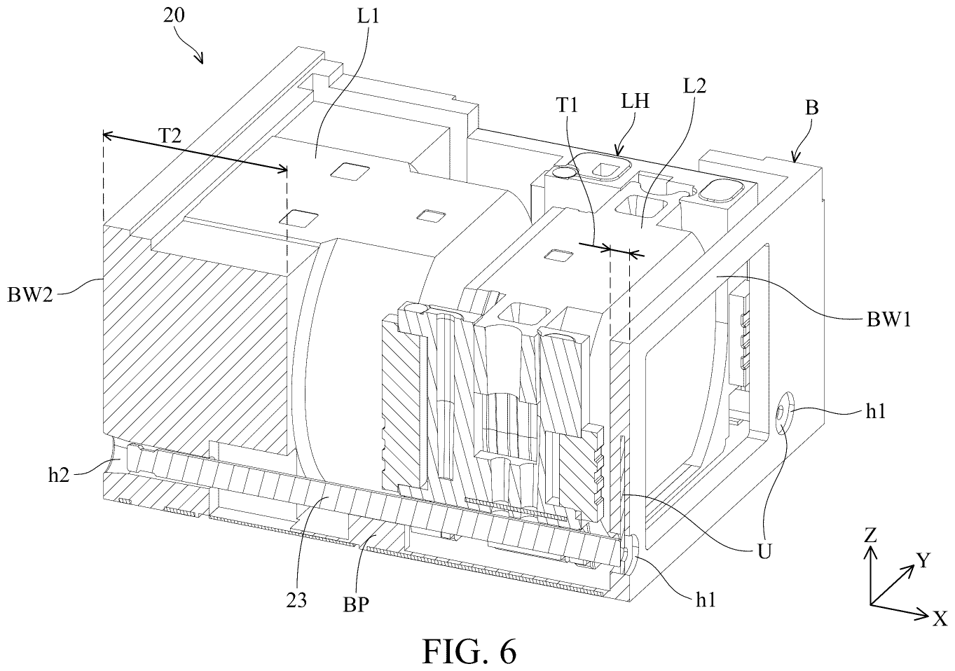

FIG. 5 shows an exploded diagram of the driving mechanism 20 in FIG. 4. FIG. 6 shows a cross-sectional view of the optical elements L1, L2 and the driving mechanism 20 after assembly, wherein the housing H is omitted from FIG. 6.

Referring to FIGS. 5-6, the driving mechanism 20 in this embodiment primarily comprises a printed circuit element 21, two rods 32 extending along the X axis, a base B, a holder LH, two magnetic elements M, two coils C, two substrate P, and a housing H.

The base B and the housing H are affixed to each other and form a fixed part of the driving mechanism 20. The holder LH is movably disposed in the base B and constitutes a movable part of the driving mechanism 20. The ends of each rod 23 are secured in a first hole h1 on the first sidewall BW1 of the base B and a second hole h2 on the second sidewall BW2 of the base B. The rods 23 extend through holder LH, and the holder LH can slide along the rods 23 in the X or −X direction.

In this embodiment, the optical element L1 is affixed to the first sidewall BW1 of the base B, and the optical element L2 is disposed in the holder LH. The first sidewall BW1 is located adjacent to the driving mechanism 10, and the second sidewall BW2 is located close to the optical element L2 and the holder LH.

The magnetic elements M (e.g. magnets) are dispose on the outer surface of the holder LH, and the substrates P are affixed to the base B. The coils C are disposed on the substrates P and located adjacent to the magnetic elements M. Here, the coils C and the magnetic elements M constitute a driving assembly of the driving mechanism 20 for moving the holder LH relative to the base B.

The printed circuit element 21 is mounted to the bottom of the base B and electrically connected to the coils C. When a current signal is applied through the printed circuit element 21 to the coils C, an electromagnetic force can be generated by the coils C and the magnetic elements M. Therefore, the holder LH and the optical element L2 on the holder LH can be driven to slide relative to the base B along the X axis, whereby the function of Auto Focusing (AF) or Optical Image Stabilization (OIS) can be achieved.

The printed circuit element 21 may be an FPCB with a thickness about 0.1 mm. Specifically, the printed circuit element 21 has a main body 211 and a bent portion 212. The main body 212 is perpendicular to the Z axis, wherein at least an electronic element E (e.g. control IC or other IC element) and a sensor S (e.g. Hall effect sensor or other magnetic field sensor) are disposed on the main body 212.

It can be seen in FIG. 6 that one end of the rod 23 is affixed to the first hole h1 on the first sidewall BW1 of the base B, and the other end of the rod 23 is affixed to the second hole h2 on the second sidewall BW2 of the base B. Moreover, the middle portion of the rod 23 is supported by a protrusion BP of the base B. In this embodiment, the rods 23 extend through the holder LH, the first sidewall BW1 has a first thickness T1 along the X axis, and the second sidewall BW2 has a second thickness T2 along the X axis, wherein the first thickness T1 is less than the second thickness T2.

Specifically, a metal sheet U is embedded in the first sidewall BW1 of the base B. For example, the metal sheet U and the base B may be integrally formed in one piece by insert molding, thus enhancing the structural strength of the first sidewall BW1. After assembly of the driving mechanism 20, a part of the metal sheet U is exposed to the first hole h1 and affixed to the rod 23.

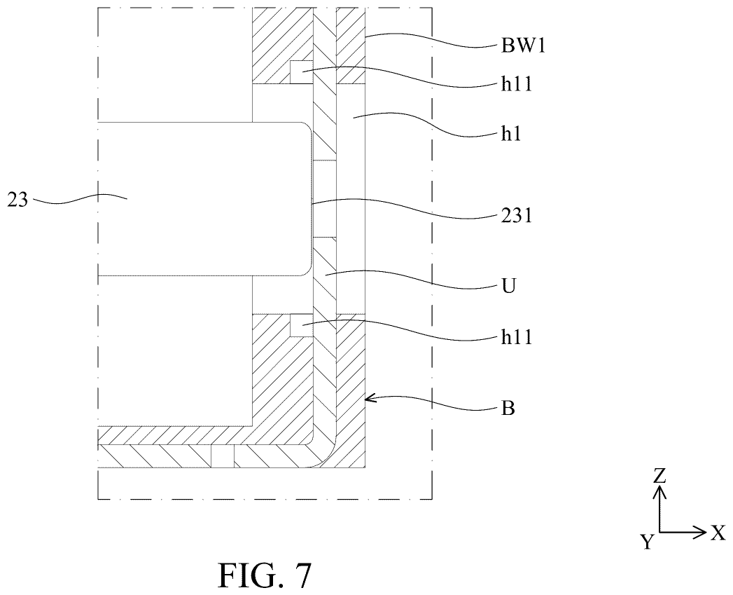

FIG. 7 shows an enlarged cross-sectional view of the first end portion 231 of the rod 23 extending into the first hole h1 of the first sidewall BW1.

Referring to FIG. 7, the first end portion 231 of the rod 23 is received in the first hole h1 of the first sidewall BW1. The metal sheet U is exposed to the first hole h1, wherein the first end portion 231 of the rod 23 and the metal sheet U can be affixed to each other in the first hole h1 by soldering/welding. Moreover, the first sidewall BW1 forms a recess h11 that is located adjacent to the metal sheet U and communicated with the first hole h1 for receiving the glue. In particular, the recess h11 can also prevent the first sidewall BW1 from being damaged during the soldering/welding process of the metal sheet U and the first end portion 231 of the rod 23.

In this embodiment, the first end portion 231 of the rod 23 does not entirely extend through the first hole h1 to protrude from the outer surface of the base B. After soldering/welding the first end portion 231 of the rod 23 to the metal sheet U, the glue can be applied in the first hole h1, and the glue can flow into the first hole h1 to enhance the connection strength between the rod 23, the metal sheet U, and the base 12.

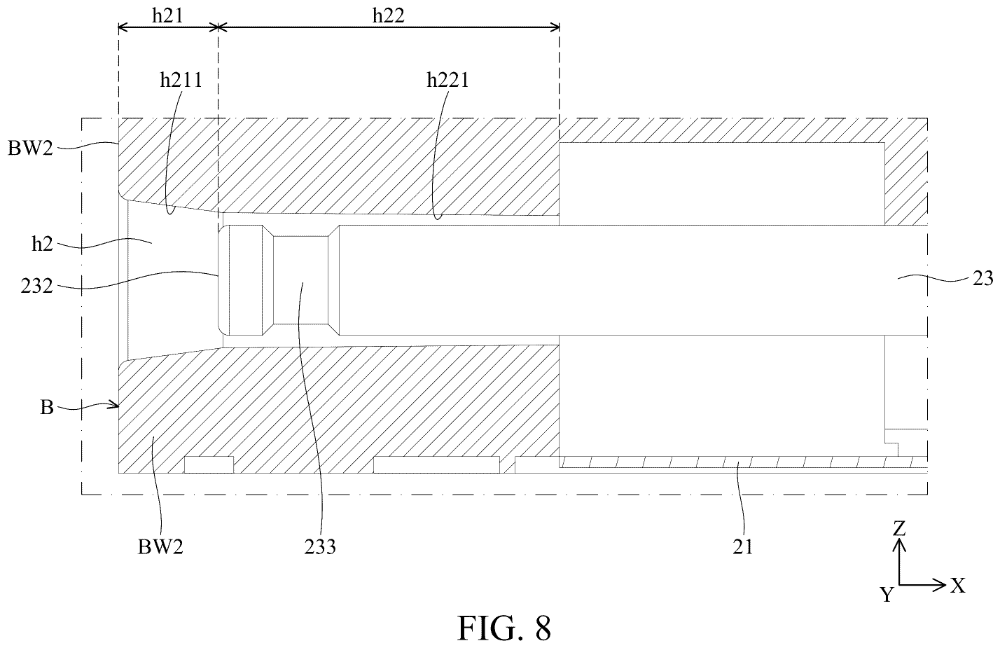

FIG. 8 shows an enlarged cross-sectional view of the second end portion 232 of the rod 23 extending into the second hole h2 of the first sidewall BW2.

Referring to FIG. 8, the second end portion 232 of the rod 23 is received in the second hole h2 of the second sidewall BW2. During assembly, the glue can be applied in the second hole h2 so that the base B and the second end portion 232 of the rod 23 are firmly affixed in the second hole h2.

In this embodiment, the second hole h2 includes a first section h21 and a second section h22, wherein the first section h21 forms a first annular sloped surface h211, and the second section h22 forms a second annular sloped surface h221, and the diameters of the first and second annular sloped surfaces h211 and h221 decrease in the X direction (horizontal direction). Specifically, the included angle (acute angle) between the first annular sloped surface h211 and the X axis is greater than the included angle (acute angle) between the second annular sloped surface h221 and the X axis.

As shown in FIG. 8, the rod 23 extends through the second section h22 to the first section h21. However, the second end portion 232 does not extends through the first section h21 to protrude from the outer surface of the base B, wherein the first section h21 is shorter than the second section h22 along the X axis.

It can be seen in FIG. 8 that the rod 23 further forms an annular channel 233 for accommodating the glue. The channel 233 is located in the second section h22 of the second hole h2 and adjacent to the second end portion 232 of the rod 23.

In some embodiments, the glue can be applied in the second hole h2 so that the second end portion 232 of the rod 23 is firmly affixed to the base B during assembly. The glue can flow through the first section h21 to the second section h22 of the second hole h2 and the channel 233 of the rod 23, thus adhering the rod 23 to the base 12.

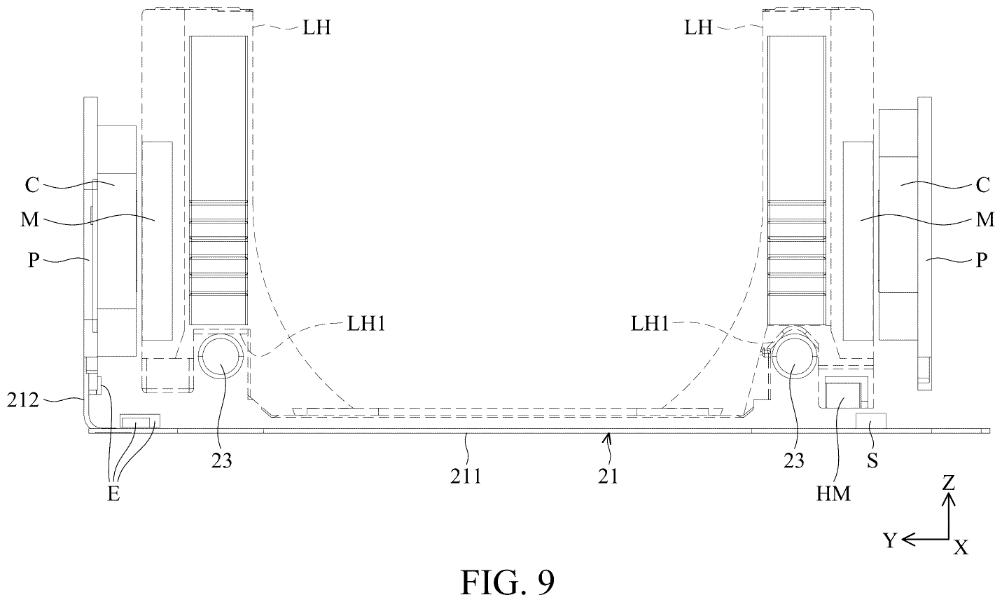

FIG. 9 shows a side view of the printed circuit element 21, the substrates P, the magnetic elements M, the coils C, the rods 32, and the holder LH after assembly.

Referring to FIG. 9, two grooves LH1 are formed at the bottom of the holder LH for receiving the rods 23. The rods 23 extend through the grooves LH1 along the X axis, whereby the holder LH can slide relative the rods 23 and the base B along the X axis.

In this embodiment, the main body 211 of the printed circuit element 21 is mounted to the bottom of the bas B. The bent portion 212 of the printed circuit element 21 is adhered to the substrate P. The sensor S on the printed circuit element 21 is located on the outer side of the two rods 23, wherein the sensor S and each of the rods 23 do not overlap in the vertical direction along the Z axis. Moreover, the magnetic elements M and the rods 23 do not overlap in the vertical direction.

It can be seen in FIG. 9 that a magnescale HM is disposed at the bottom of the holder LH, wherein the sensor S and the magnescale HM at least partially overlap in the vertical direction along the Z axis. It should be noted that the sensor S can detect the position of the magnescale HM, whereby the displacement of the holder LH and the optical element L2 relative to the base B along the X axis can be obtained.

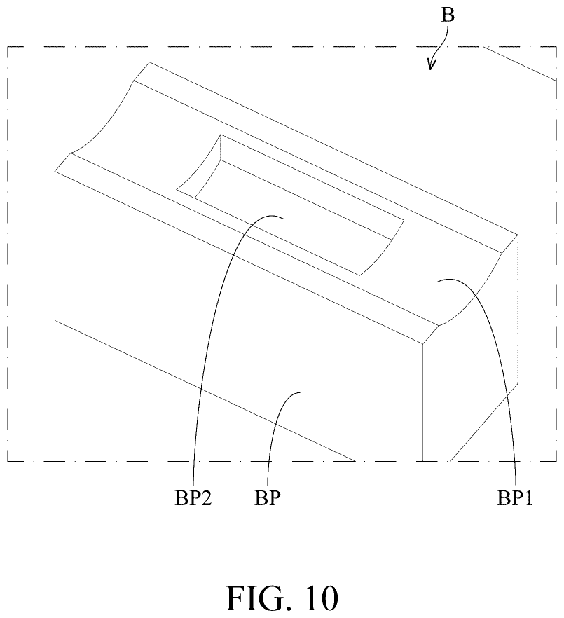

FIG. 10 shows a perspective view of a curved surface BP1 and a cavity BP2 formed on the protrusion BP of the base B.

Referring to FIGS. 6 and 10, the protrusion BP is formed on the bottom surface of the base B to support the rod 23. The protrusion BP is located between the first and second sidewalls BW1 and BW2 along the X axis (FIG. 6). Specifically, the protrusion BP forms a curved surface BP1, and the rod 23 is disposed on the curved surface BP1.

In this embodiment, the radius of curvature of the curved surface BP1 is greater than the radius of curvature of the rod 23. Additionally, a cavity BP2 is formed at the center of the curved surface BP1 for receiving the glue, thus enhancing the connection strength between the rod 23 and the base B.

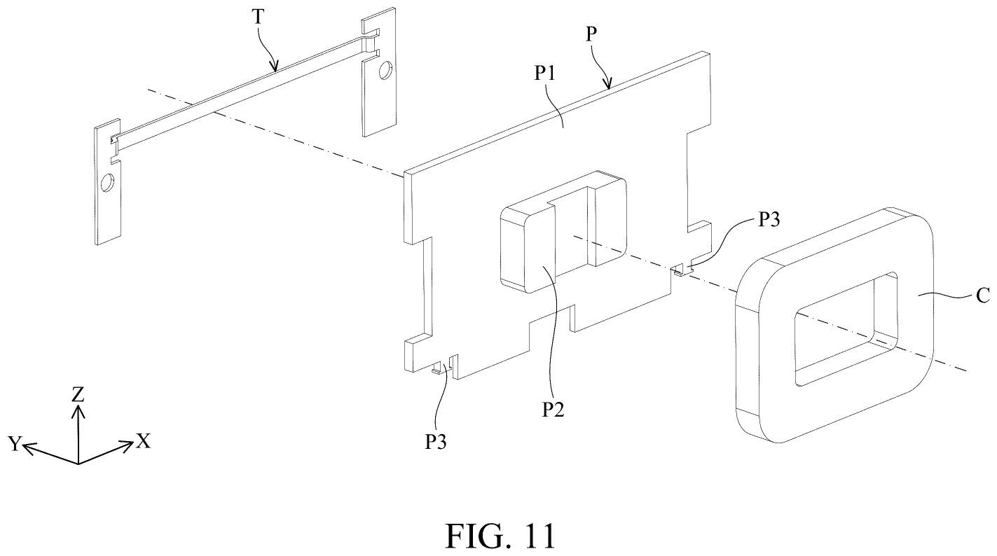

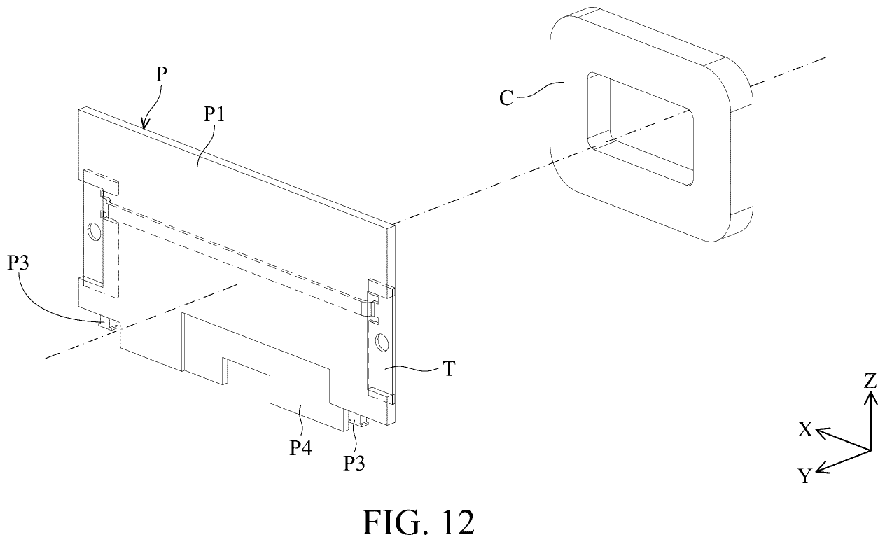

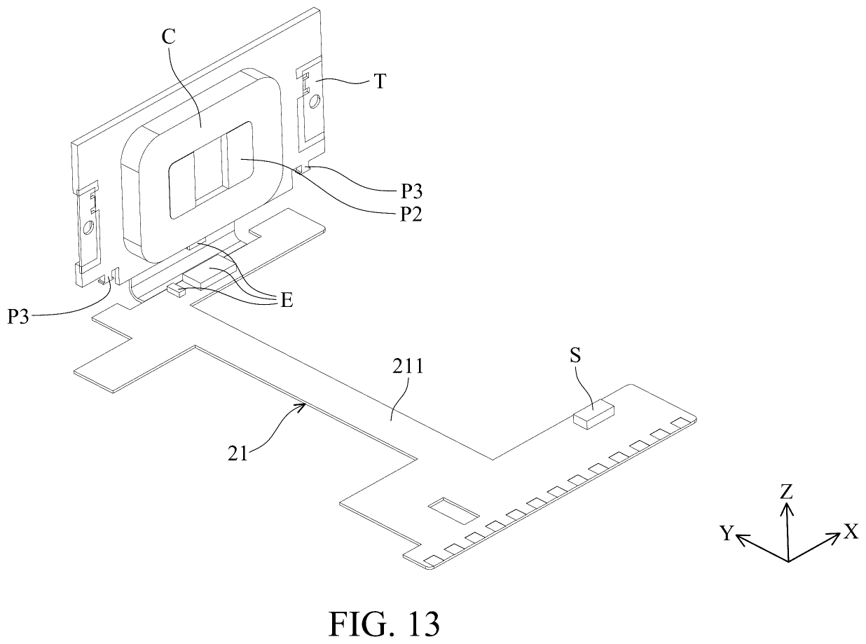

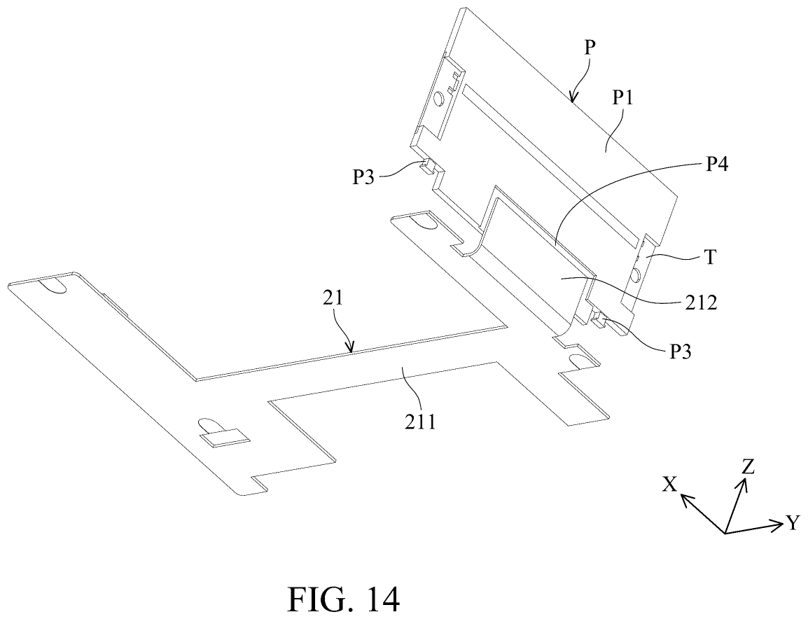

FIG. 11 shows an exploded view of the substrate P, the coil C, and a metal frame T in FIG. 5. FIG. 12 shows another exploded view of the substrate P, the coil C, and the metal frame T in FIG. 5. FIG. 13 shows a perspective diagram of the substrate P, the coil C, and the metal frame T after assembly. FIG. 14 shows another perspective diagram of the substrate P, the coil C, and the metal frame T after assembly.

Referring to FIGS. 11-14, the substrate P in this embodiment has a flat structure P1, a protrusion P2, and two winding posts P3. The thickness of the flat structure is equal to or greater than 0.2 mm (e.g. 0.3 mm). The protrusion P2 protrudes from the flat structure P1 toward the magnetic element M, and the winding posts P3 protrudes from the bottom of the flat structure P1 in the −Z direction. During assembly, the coil C can be disposed around the protrusion P2, and two wires (not shown) connect the coil C to the winding posts P3. The wires on the winding posts P3 can be bonded to the conductive members on the base B by soldering/welding, whereby the coil C can be electrically connected the printed circuit element 21 and an external circuit through the wires and the conductive members.

To enhance the structural strength of the plastic substrate P, an H-shaped metal frame T may be integrally formed with the substrate P in one piece by insert molding. Thus, deformation of the substrate P can be prevented when an external force is exerted on the driving mechanism 20.

Moreover, as shown in FIGS. 12 and 14, the substrate P further has a depressed portion P4 for receiving the bent portion 212 of the printed circuit element 21, thus facilitating miniaturization of the driving mechanism 20.

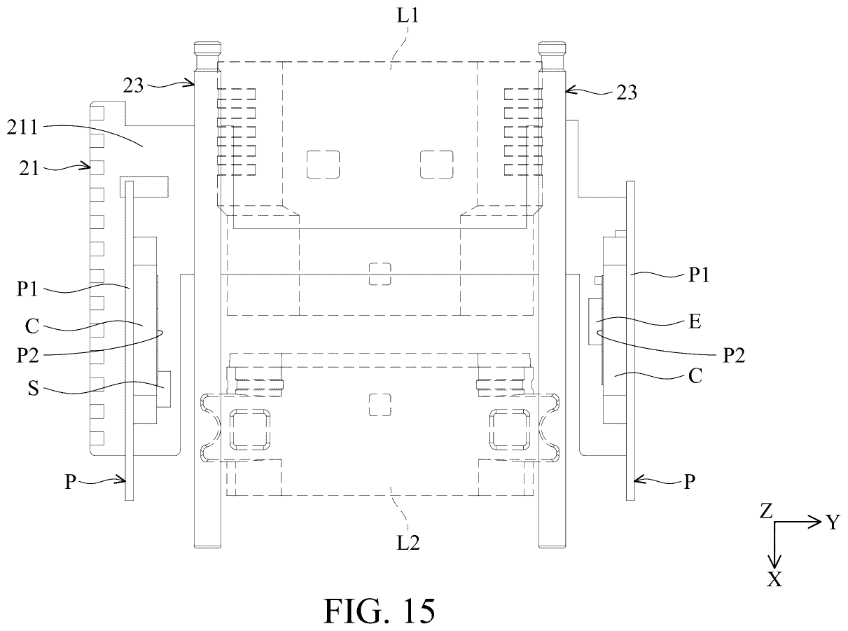

FIG. 15 shows a top view of the optical elements L1, L2, the rods 23, the printed circuit element 21, the substrates P, and the coils C after assembly.

Referring to FIG. 15, after assembly of the driving mechanism 20, the optical elements L1, L2 and the rods 23 partially overlap along the Z axis. In some embodiments, the optical elements L1, L2 and the rods 23 may not overlap along the Z axis, and the optical elements L1, L2 are situated between the two rods 23 along the Y axis, wherein one of the rods 23 is situated between the sensor S and the optical element P1, P2 when viewed along the Z axis.

Moreover, as shown in FIG. 15, the protrusion P2 protrudes from the coil C toward the magnetic element M, wherein the thickness of the protrusion P2 along the Y axis is greater than the thickness of the coil C along the Y axis. With the configuration as described above, when an external force is exerted on the driving mechanism 20, the coil C can be prevented from direct collision with the magnetic element M on the holder LH.

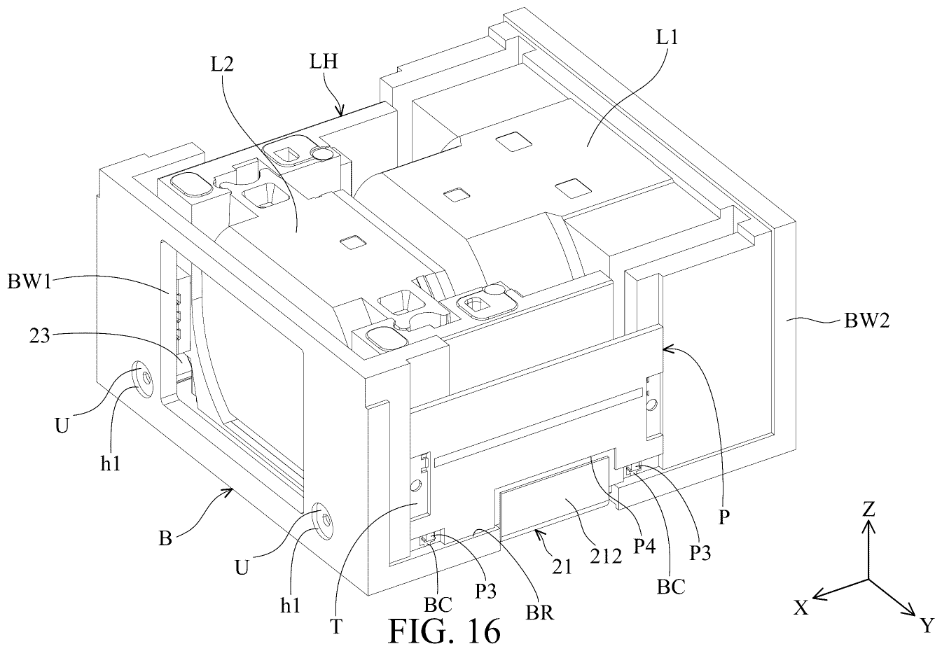

FIG. 16 shows a perspective diagram of the driving mechanism 20 when the housing H is removed therefrom.

Referring to FIG. 16, one of the substrates P is mounted on a side of the base B during assembly, wherein the flat structure P1 of the substrate P abuts a restricting surface BR of the base B. Specifically, the winding posts P3 may have a T-shaped or L-shaped structure, and the wires (not shown) wound on the winding posts P3 can be bonded to the conductive members BC that are exposed on the lateral surface of the base B by soldering/welding. Hence, the coil C can be electrically connected to the external circuit sequentially through the wires, the conductive members BC, and the printed circuit element 21 below the base B.

In this embodiment, the conductive members BC may be integrally formed with the base B in one piece by insert molding, wherein the conductive members BC are exposed to a side of the base B, and the winding posts P3 and the conductive members BC are located close to the restricting surface BR of the base B.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, compositions of matter, means, methods and steps described in the specification.

As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. Moreover, the scope of the appended claims should be accorded the broadest interpretation so as to encompass all such modifications and similar arrangements.

While the invention has been described by way of example and in terms of preferred embodiment, it should be understood that the invention is not limited thereto. On the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A driving mechanism for moving an optical element, comprising:
a fixed part;
a movable part, movably connected to the fixed part for holding the optical element; and
a driving assembly, configured for moving the movable part relative to the fixed part.

2. The driving mechanism as claimed in claim 1, further comprising a rod extending in a horizontal direction, wherein the fixed part includes a base and a housing connected to each other, the rod is affixed to the base, and the movable part is slidably disposed on the rod.

3. The driving mechanism as claimed in claim 2, further comprising a printed circuit element, a magnescale, and a sensor, wherein the printed circuit element is affixed to the base, the magnescale is disposed on the movable part, and the sensor is disposed on the printed circuit element for detecting the position of the magnescale.

4. The driving mechanism as claimed in claim 3, wherein the printed circuit element has a main body and a bent portion connected to the main body, the sensor is disposed on the main body, and the main body is perpendicular to a vertical direction, wherein the sensor and the magnescale at least partially overlap in the vertical direction.

5. The driving mechanism as claimed in claim 4, wherein the sensor and the rod do not overlap in the vertical direction.

6. The driving mechanism as claimed in claim 4, wherein the optical element and the rod partially overlap in the vertical direction.

7. The driving mechanism as claimed in claim 4, wherein the optical element and the rod do not overlap in the vertical direction, and the rod is situated between the optical element and the sensor when viewed in the vertical direction.

8. The driving mechanism as claimed in claim 4, further comprising two rods extending in the horizontal direction, wherein the movable part forms two grooves, and the rods are received in the grooves.

9. The driving mechanism as claimed in claim 8, wherein the sensor is located on an outer side of the rods.

10. The driving mechanism as claimed in claim 4, further comprising a substrate affixed to the base, wherein the driving assembly includes a magnetic element and a coil located close to the magnetic element, the magnetic element is disposed on the movable part, and the coil is disposed on the substrate.

11. The driving mechanism as claimed in claim 10, wherein the magnetic element and the rod do not overlap in the vertical direction.

12. The driving mechanism as claimed in claim 10, wherein the sensor, the magnescale, and the magnetic element at least partially overlap in the vertical direction.

13. The driving mechanism as claimed in claim 10, wherein the substrate has a depressed portion for receiving the bent portion of the printed circuit element.

14. The driving mechanism as claimed in claim 10, further comprising a metal frame embedded in the substrate.

15. The driving mechanism as claimed in claim 14, wherein the metal frame has an H-shaped structure.

16. The driving mechanism as claimed in claim 10, wherein the substrate has a flat structure and a protrusion protruding from the flat structure, the protrusion extends through the coil toward the magnetic element, and the thickness of the protrusion is greater than the thickness of the coil.

17. The driving mechanism as claimed in claim 16, wherein the thickness of the flat structure is equal to or greater than 0.2 mm.

18. The driving mechanism as claimed in claim 16, further comprising a wire, wherein the substrate has a winding post extending from a bottom side of the flat structure, the winding post has a T-shaped or L-shaped structure, and the wire is connected to the coil and wound on the winding post.

19. The driving mechanism as claimed in claim 18, wherein the flat structure abuts a restricting surface of the base, and the winding post is located close to the restricting surface.

20. The driving mechanism as claimed in claim 18, further comprising a conductive member embedded in the base, wherein a part of the conductive member is exposed to a side of the base and bonded to the wire by soldering or welding.
